(19) United States
(12) Patent Application Publication
(10) Pub. No.: US 2016/0049013 A1
(43) Pub. Date: Feb. 18, 2016

(54) Systems and Methods for Managing Augmented Reality Overlay Pollution

(71) Applicant: Martin Tosas Bautista, Manchester (GB)

(72) Inventor: Martin Tosas Bautista, Manchester (GB)

(21) Appl. No.: 14/824,488

(22) Filed: Aug. 12, 2015

(30) Foreign Application Priority Data
Aug. 18, 2014 (GB) GB1414609.6
Aug. 12, 2015 (GB) GB1514347.2

(51) Int. Cl. G06T 19/00; G06F 3/01

(52) U.S. Cl. CPC G06T 19/006; G06F 3/013

(57) ABSTRACT

A system and method enabling an Augmented Reality (AR) capable system to manage the displaying of AR overlays in ways that prevent possible AR user distractions, respect AR user's privacies and prevent interference or conflict with other AR overlays that may appear in an AR user's field of view.

### FIELD OF THE INVENTION

This invention relates to systems and methods for dealing with issues that may occur during the presentation of Augmented Reality overlays.

### BACKGROUND

With increasing numbers of smartglasses, holographic projection systems and other Augmented Reality (AR) hardware being developed, AR is expected to become the next big media revolution. As AR systems and methods proliferate and become more commonplace, future AR users will face new challenges to deal with the increasing numbers of available AR overlays in an efficient manner.

### SUMMARY

The invention is directed towards systems and methods for dealing with or managing Augmented Reality (AR) overlays in ways that prevent AR user distractions, respect privacies and prevent interference with other AR overlays that may appear on an AR users field of view. A high number of AR overlays appearing simultaneously or in quick succession in a users field of view can be detrimental to the AR experience. In some instances a large number of AR overlays on the users field of view can result in undesired distractions from the real scene. This may occur when using any AR capable hardware. The results of these undesired distractions, depending on the scenario, may range from mild annoyances and disturbances to dangerous hazards. AR overlays that appear as undesired distractions to a user are referred to in this disclosure as AR overlay pollution. Another form of AR overlay pollution is when AR overlays interfere with each other. And yet another form of AR overlay pollution is when the AR overlays appear at unwanted or private locations.

There is a clear need for systems and methods than can automatically control or manage the presentation of AR overlays to AR users in a smart way that prioritises safety for the AR user, efficiency in presenting the information, privacy, and the AR users personal preferences.

Further features and advantages of the disclosed invention, as well as the structure and operation of various embodiments, are described in detail below with reference to the accompanying drawings. It is noted that the present invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form part of the specification, illustrate embodiments of the present invention and, together with the description, further serve to explain the principles involved and to enable a person skilled in the relevant art(s) to make and use the disclosed invention.

FIG. 1A shows a state diagram of the life cycle of an AR overlay within the AR users field of view.

FIG. 1B shows an exemplary architecture that embodiments of the invention may use.

FIG. 2A represents a store shelf with some products that may have AR information attached to them.

FIG. 2B shows how two of the products on the shelf are briefly flashed once they are detected. The flashing of the products constitutes a form of pre-informational AR overlay.

FIG. 2C shows that the two products that had been flashed in FIG. 2B are now highlighted with less intensity, or flashing slowly, waiting to meet criteria to become full informational AR overlays.

FIG. 2D shows that one of the products that was displaying a pre-informational AR overlay is now displaying an informational AR overlay.

FIG. 3A shows a driveway to a house. In the middle of the driveway there is an unattached AR overlay that can't yet be seen in this figure.

FIG. 3B shows an unattached AR overlay appearing in the middle of the driveway, presented in a pre-informational AR overlay form.

FIG. 3C shows an unattached AR overlay that has just transitioned from a pre-informational form to an informational form.

FIG. 4A shows an example situation where an AR user wearing smartglasses, or any other suitable AR hardware, can see a number of unattached AR overlays, in pre-informational form, floating above the central part of the AR users field.

FIG. 4B the AR user has selected one of the AR overlays that was floating above. The AR overlay has flown or moved towards the AR user stopping at a predetermined distance that allows suitable inspection by the AR user.

FIG. 5 shows a flowchart of a FIFO approach for the management of AR overlay pollution.

FIG. 6 illustrates the use of a spherical spatial boundary to enable or disable AR overlays.

FIG. 7 shows how a circular buffer zone, centred on a first AR overlay, may be used to prevent the presentation of the other AR overlays within the buffer zone.

FIG. 8 shows how a buffer zone, determined by the repeated morphological dilation of the contour of an AR overlay, may be used to prevent the presentation of the other AR overlays within the buffer zone.

FIG. 9 shows a map including a exclusion area within which certain AR overlays may not be displayed.

FIG. 10 shows a flowchart of an implementation of an exclusion area at the time of anchoring an unattached AR overlay.

FIG. 11 shows a flowchart of an implementation of an exclusion area with a verification step during the presentation of the AR overlay.

FIG. 12 shows a flowchart of an implementation of the AR server labelling a bundle of AR overlays before sending it to an AR device.

FIG. 13 shows a flowchart of an implementation of labelling attached AR overlays depending on the location of the recognised objects.

The features and advantages of the disclosed invention will become more apparent from the detailed description set forth below when taken in conjunction with the drawings, in which like reference characters identify corresponding elements throughout. In the drawings, like reference numbers generally indicate identical, functionally similar and/or structurally similar elements. The drawing in which an element first appears is indicated by the leftmost digit(s) in the corresponding reference number.

### DETAILED DESCRIPTION OF THE DRAWINGS

The invention is directed towards systems and methods for dealing with or managing Augmented Reality (AR) overlays in ways that prevent AR user distractions, respect privacies and prevent interference with other AR overlays that may appear on an AR users field of view.

AR is expected to become the next big media revolution. As AR systems and methods proliferate and become more commonplace, future AR users will face new challenges in dealing with the increasing numbers of available AR overlays in an efficient manner. An AR overlay refers to any 2D or 3D virtual information layers or tags that are superimposed, displayed, or presented in an AR users field of view.

A high number of AR overlays presented simultaneously or in quick succession in an user's field of view can be detrimental to the AR experience. In some instances a high number of AR overlays on the user's field of view can result in undesired distractions from the real scene. This can occur, for example, when smartglasses or other types of Head Mounted Displays (HMD) are being used, especially if they may cover the entire users field of view. The results of these undesired distractions, depending on the scenario, may range from mild annoyances and disturbances to dangerous hazards. AR overlays that appear as undesired distractions to a user are referred to in this disclosure as AR overlay pollution. Another form of AR overlay pollution is when AR overlays interfere with each other. And yet another form of AR overlay pollution is when the AR overlays appear at unwanted or private locations.

There is a clear need for systems and methods than can automatically control or manage the presentation of AR overlays to AR users in a smart way that prioritises safety for the AR user, efficiency in presenting the information, privacy, and the AR users personal preferences.

### Exemplary Architecture

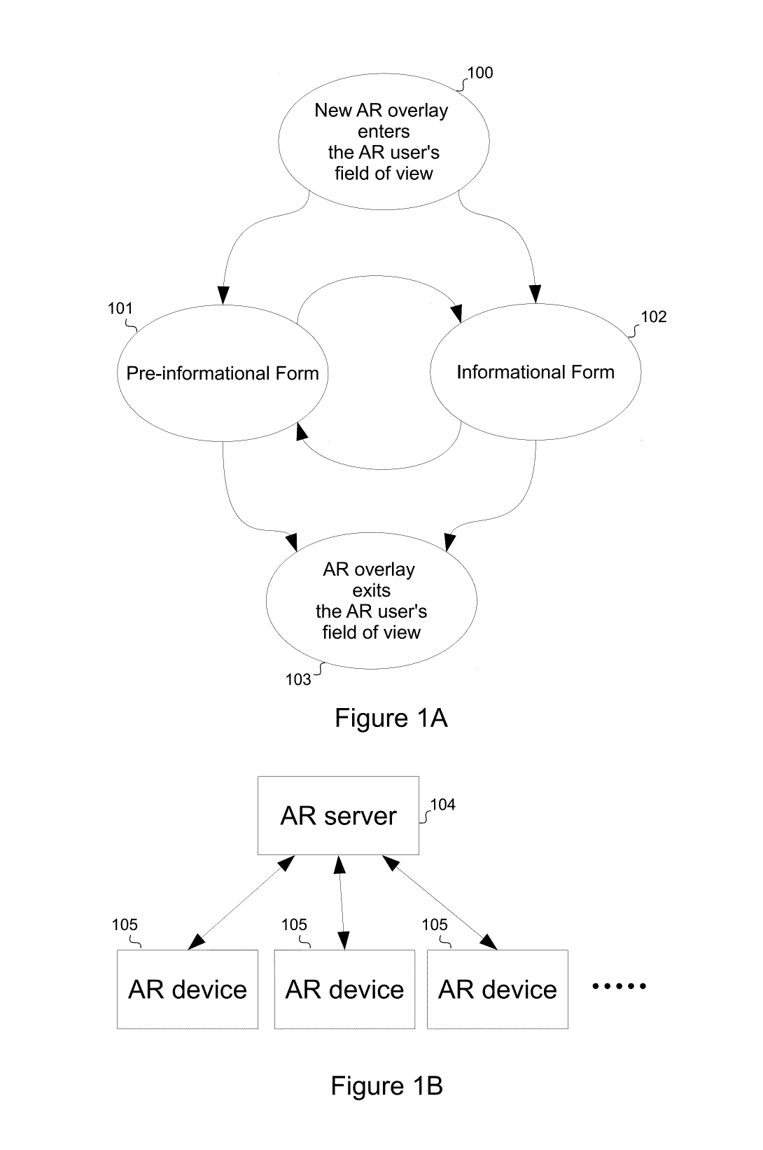

FIG. 1B shows an exemplary architecture that embodiments of the invention may use. In this diagram the AR device 105 refers to any AR capable device, such as smartphones, PDAs, smartglasses, HMDs, Head-Up Displays (HUDs), including HUDs on vehicle windscreens, etc. These AR devices 105 may include hardware such as cameras, motion sensors, geolocation subsystems, and wireless network access. Typically, the AR device 105 may perform some position and orientation localization tasks that enable displaying AR overlays on the AR users field of view. These localization tasks may involve the use of computer vision detection and tracking, Simultaneous Mapping and Tracking (SLAM) techniques, motion sensors fusion, geolocation subsystems, etc. The AR devices 105 may decide which AR overlays should be presented in an AR users field of view by integrating local and or remote data.

Embodiments of the invention may also involve an AR server 104, which may be a single computer, a distributed network of computers, cloud services etc. to which the AR devices 105 are connected to through wireless network access. The AR server 104 will store information related to the AR overlays, such as contents, appearance, location, and various other related metadata, and may communicate this information to the AR devices 105 so that they can display the relevant AR overlays. The AR server 104 may also perform some other tasks related with the control of the presentation of AR overlays in the individual AR devices 105. For example, the AR server may decide which AR overlays a certain AR device may show in the AR users field of view by integrating data from multiple sources, such as databases, other AR device's information, other networks information, etc.

### AR Overlay Pollution Due to High Number of AR Overlays

Often AR overlays may be filtered by channel or category but this may not be desirable in some situations. Even if these filters are in place, the potential for AR overlay pollution can still exist if too many AR overlays in the same channel or category are shown simultaneously or in quick succession, covering a substantial part of the AR users field of view.

Depending on the types of AR overlays and their applications, the systems and methods for dealing with AR overlay pollution can vary.

AR overlays can be attached to real life objects, for example, supermarket items, photos in a magazine, faces of people, etc. These real life objects can currently be recognized to different degrees of accuracy by using image processing techniques which are available in AR SDKs such as Vuforia, Metaio, and others. If the recognition (typically image recognition) of these objects occurs on multiple objects simultaneously or in quick succession, and the displaying of an informational AR overlay related to each object occurs as a result of each recognition, all the AR overlays may show simultaneously, or in quick succession, on the users field view. This can be distracting, overwhelming, or even dangerous to the AR user, depending on the scenario. In this disclosure, we will refer to the type of AR overlays which are attached to real life objects, as attached AR overlays.

In addition to attached AR overlays, AR overlays can be shown anywhere, including floating in mid-air while keeping a world referenced position and orientation. The type of AR overlays which float in mid-air can be implemented using systems such as the one disclosed in the patent named “System and method of interaction for mobile devices” U.S. Ser. No. 14/191,549 or the well known PTAM (Parallel Tracking and Mapping) system. Geolocation, microlocation, and various motion sensors can also be used to implement this type of AR overlay. In this disclosure, we will refer to the type of AR overlays which have a world referenced position and orientation but are not specifically attached to a real life object, as unattached AR overlays. Unattached AR overlays placed by organizations such as governments, companies, etc. may be expected to be reasonably located, considering an AR user's field of view, in such a way as to minimize AR overlay pollution. However, the risk of AR overlay pollution still exists. Among the multiple applications of unattached AR overlays, social media platforms where AR users can freely place their own informational AR overlays wherever they wish and share them with the general public, are inevitable. In these type of applications, regulations about where to place the unattached AR overlays will be difficult to implement. Therefore systems and methods that can automatically control the presentation of unattached AR overlays to AR users in a smart way, will be very useful.

Some embodiments of the invention manage AR overlay pollution, due to the presentation of high numbers of AR overlays, by implementing two states or forms that may be taken by AR overlays. The first stage is referred to as pre-informational AR overlay form, and the second state is referred to as informational AR overlay form.

A pre-informational AR overlay is an AR overlay that may be displayed in the AR user's field of view in a way that can be perceived by the AR user but it is not too prominent. The main purpose of a pre-informational AR overlay is to communicate to the AR user that there is information that can be accessed, probably in the form of a more prominent informational AR overlay. The pre-informational AR overlay may be displayed in a way that does not distract or interfere with the AR user interactions with the real world, with other AR overlays, or with any other form of human computer interaction that may be in progress.

An informational AR overlay is an AR overlay that may be displayed in the AR user's field of view in a way that can distinctly be perceived by the AR user. The main purpose of an informational AR overlay is to communicate relevant information to an AR user. The informational AR overlay may be displayed in a way that attracts the attention of the AR user.

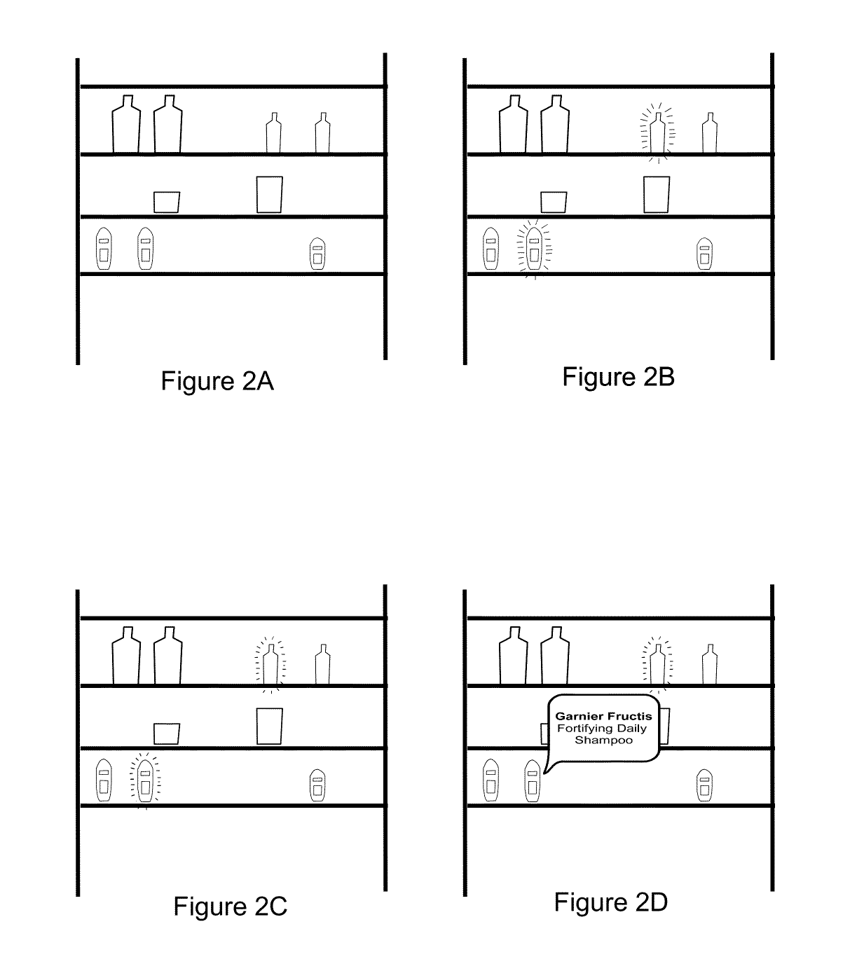

When the AR overlay is an attached AR overlay, a pre-informational AR overlay may involve briefly flashing or highlighting the contour of the associated object, as seen in the AR users field of view, in a way that is detectable but not too prominent. Alternatively the object associated with the attached AR overlay may change colour, change intensity, be surrounded by an oval or rectangle overlay, be pointed out with an arrow overlay, have perpendicular lines intersecting at the position of the object, etc. in a way that can be perceived by the AR user but is not too prominent. The highlighted object may then remain highlighted with less intensity, slower flashing, changed colour, pointed out with a smaller arrow, etc. until the object exits the AR users field of view, or criteria is met for turning the pre-informational AR overlay into an informational AR overlay or turning it off completely. FIG. 2A to FIG. 2D show an example use of a pre-informational and an informational AR overlay for the attached AR overlay case. FIG. 2A represents a store shelf containing products that may have AR information attached to them. FIG. 2B shows how two of the products on the shelf are briefly flashed once they are detected. The flashing of the products constitutes a form of pre-informational AR overlay. FIG. 2C shows that the two products that had been flashed in FIG. 2B are now highlighted with less intensity, or flashing slowly, waiting to meet criteria to become full informational AR overlays. FIG. 2D shows that one of the products that was displaying a pre-informational AR overlay is now displaying an informational AR overlay. The transition may have been produced by user selection, or automatically produced by the AR system.

When the AR overlay is an unattached AR overlay, a pre-informational AR overlay may involve flashing or highlighting the associated informational AR overlay in a way that can be perceived by the AR user but is not too prominent. Alternatively, the informational AR overlay may be displayed with less intensity or more transparency, be a different colour, be surrounded by an oval or rectangle overlays, be pointed out with an arrow overlay, have perpendicular lines intersecting at the position of the unattached AR overlay, etc. The unattached AR overlay may then remain in a pre-informational form involving dimmer highlighting, slower flashing, changed colour, changed intensity, semi-transparency, pointed out with an arrow, etc. until the unattached AR overlay exits in the AR users field of view, or criteria are met for turning the pre-informational AR overlay into an informational AR overlay.

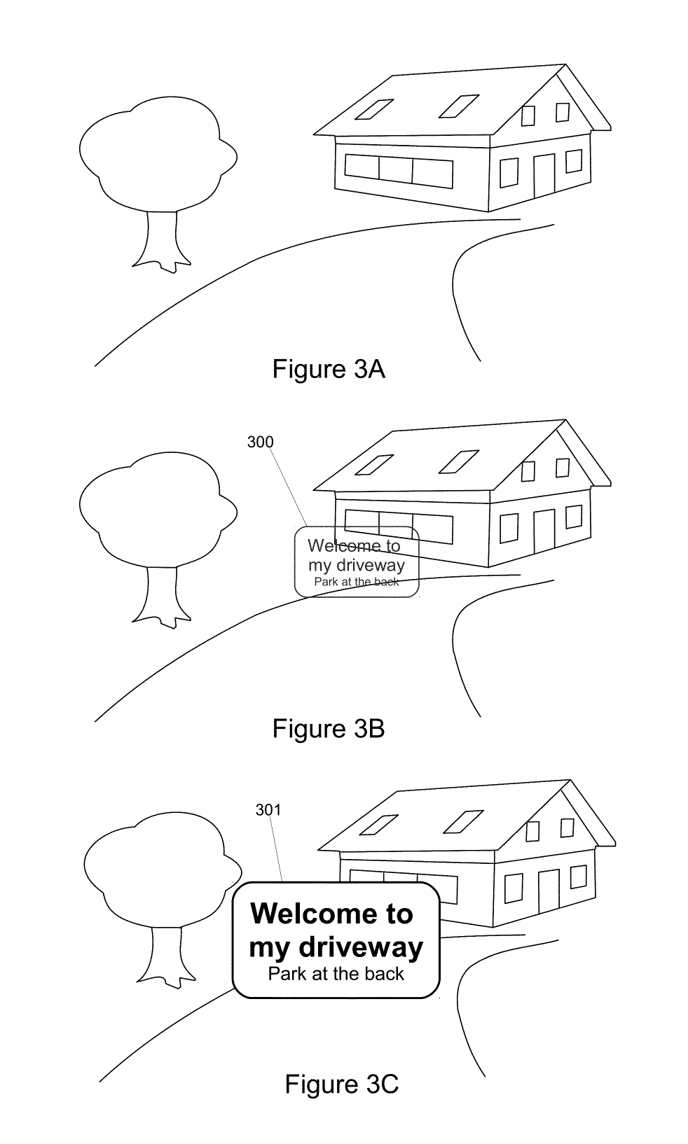

FIG. 3A shows a driveway to a house. In the middle of the driveway there is an unattached AR overlay that can't yet be seen in this figure. FIG. 3B shows an unattached AR overlay appearing in the middle of the driveway, presented in a pre-informational AR overlay form. The first time this overlay appears it may flash, or be highlighted in a way that can be perceived by the AR user but is not too prominent. After the initial flash, the AR overlay may continue in pre-informational form, with reduced intensity, slower flashing or semi-transparency (300). FIG. 3C shows the same scene but now the AR overlay takes an informational AR overlay form, 301. This informational AR overlay form will stand out from the scene and attract the AR users attention.

AR overlays that may appear in the AR users field of view may be displayed first as pre-informational AR overlays, and then, if certain criteria are met, they will be converted to informational AR overlays. FIG. 1A shows a state diagram of the life cycle of an AR overlay within the AR users field of view. Initially the AR overlay enters the AR users field of view, 100. Depending on the configuration of the AR system, the system may decide to display a pre-informational AR overlay first, 101. This may be, for example, because the AR users field of view is already too full with AR overlays, because there is a more important AR overlay in the scene or simply because this is the default configuration. Alternatively, the AR system may decide to display the informational AR overlay first, 102. This may be, for example, because there are no other AR overlays on the AR users field of view, because that particular AR overlay has an associated high priority; or simply because this is the default configuration. An AR overlay in pre-informational form, 101, may change into an informational form, 102, because certain criteria are met. For example, the AR user may select the pre-informational AR overlay with the intention of seeing the informational form of it; the AR users field of view may show enough free area to display an informational AR overlay; or the priority of the AR overlay may increase due to proximity or motion toward the AR user. The opposite may occur as well, i.e. the informational AR overlay, 102, may turn into a pre-informational AR overlay, 101. For example, if the AR users field of view becomes too cluttered with AR overlays; a more important AR overlay appears on the AR user's field of view; or the AR user may manually turn the informational AR overlay into a pre-informational AR overlay. Finally, when the AR overlay exits the AR users field of view, 103, the AR overlay is disabled.

Both attached and unattached AR overlay pollution can be managed by using one embodiment of the invention referred to as “flash and wait”. This embodiment of the invention involves two stages. The first stage involves displaying a pre-informational AR overlay. The second stage involves the AR user selecting the pre-informational AR overlay displayed during the first stage, and this action revealing the informational AR overlay.

The selection of a specific pre-informational AR overlay may vary depending on the available interaction methods of the AR system. For example, if the AR system uses hand tracking, finger tracking, or some form of hardware pointer that the AR user can use to make selections in its field of view, this method can be used to select the previously highlighted object or pre-informational AR overlay and reveal its associated informational AR overlay. If the AR system uses gaze tracking, the AR user may select the pre-informational AR overlay by fixing their gaze on it for a predetermined amount of time, after which the informational AR overlay may be displayed. In an alternative embodiment of the invention, the AR system may use a selecting region of the AR users field of view that is head referenced to make a selection of a pre-informational AR overlay. This would be achieved by aiming the user's head in the appropriate direction, centring the selecting region on the pre-informational AR overlay, and holding that view for a predetermined amount of time, after which the informational AR overlay may be displayed. In both cases, (the gaze tracking or the centring of a selecting region of the users field of view) an alternative method of selection may be possible using hardware that can read the brain waves of the AR user to determine selection actions. This hardware may be used to select the previously highlighted object or pre-informational AR overlay. FIG. 3C shows an unattached AR overlay that has just transitioned from a pre-informational form to an informational form. In a “flash and wait” approach the AR user would have manually selected the pre-informational AR overlay, 300, in order to have turned it into an informational AR overlay, 301.

In some embodiments of the invention the AR system may override the AR user's selection, and show an informational AR overlay even if the AR user didn't select it. Similarly, the AR system may not show an informational AR overlay even if the AR user did select it.

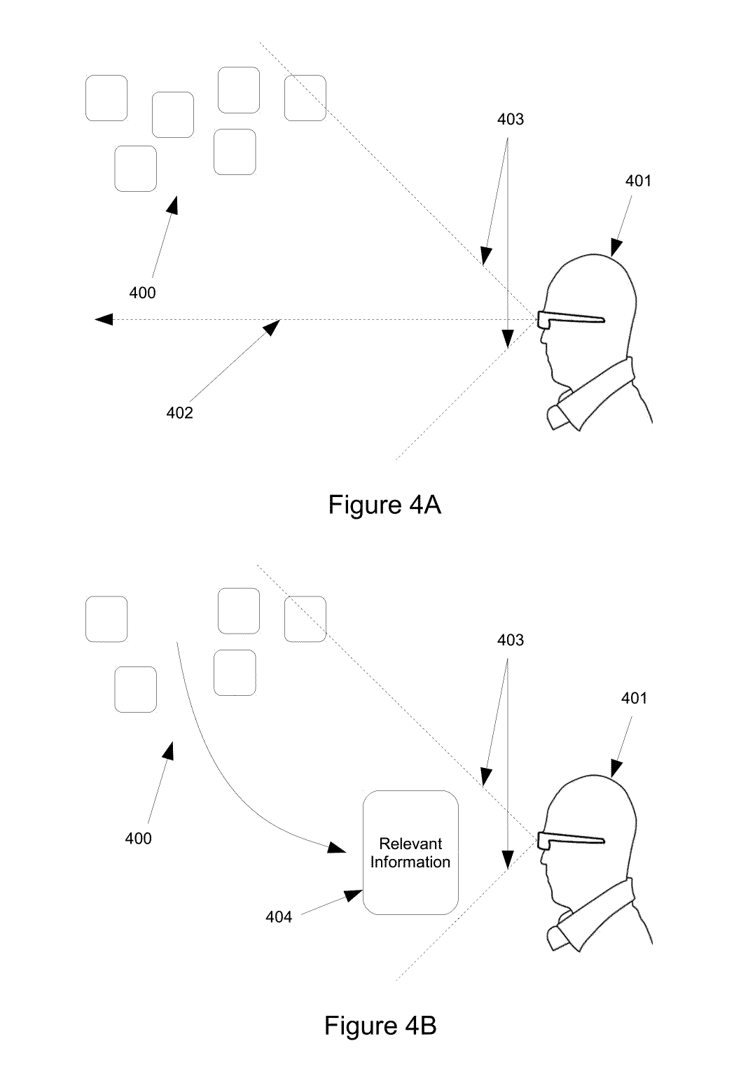

In some embodiments of the invention, the pre-informational AR overlays may be placed voluntarily, by the AR overlay creator, or automatically, by the AR system, in regions that would not interfere or distract the AR user. These embodiments of the invention are referred to as “placed out of the way”. Unattached AR overlays may be freely placed and shared by individuals, for example using social media platforms. The individuals may choose, as following a certain etiquette, to place these AR overlays, possibly in pre-informational form, at a predetermined distance from the AR user, for example, floating above the users field of view. Alternatively, even if AR users do not follow any etiquette rules when placing unattached AR overlays, the AR system may force the AR overlays to remain out of the way, or it may present a rearranged view of the AR overlay to each individual AR user so that the AR overlays are displayed out of the way. For example, unattached AR overlays may be automatically placed flying above the AR users field of view, therefore not interfering with the viewing of the real scene. On a second stage, an AR user may decide to further inspect one of the AR overlays that has been “placed out of the way”, possibly in pre-informational form. The AR user can achieve this by selecting the AR overlay using any of the previously mentioned methods of selection. The AR overlay can then fly, or be attracted, towards the AR user and stop at a predetermined distance and at a comfortable view angle from the AR user. The AR overlay may then take its corresponding informational form. FIG. 4A shows an example situation where an AR user, 401, wearing smart glasses, or any other suitable AR hardware, can see a number of unattached AR overlays, 400, in pre-informational form, floating above the central part of the AR user's field of view, 402. The AR user can just see the AR overlays, 400, without having to look upwards, because these AR overlays are within the AR user's field of view, 403. However, these AR overlays don't pollute the central and most important part of the AR user's field of view, 402. In FIG. 4B the AR user has selected one of the AR overlays, 404, that was floating above his field of view. The AR overlay, 404, has flown or been attracted towards the AR user, stopping at a predetermined distance that allows suitable inspection by the AR user. At this point, the AR overlay, 404, may turn into its informational form. Once the AR user, 401, has inspected the AR overlay, he may return it to its original location (and pre-informational form) by just selecting it again, or the AR overlay may automatically return to its original location after a predetermined period of time.

In this disclosure the AR users visibility is defined as a percentage:

AR users visibility=100*(1−“total overlay area”/“field of view area”) (Eq. 1)

In the above formula the “total overlay area” refers to the area covered by all the AR overlays visible in the AR user's field of view. Notice that this area may be smaller than the sum of the areas of the individual AR overlays in the AR user's field of view. The reason for this is that overlapping between the various AR overlay may occur. The correct computation here is the area of the union of the areas covered by individual AR overlays in the AR user's field of view. The “field of view area” refers to the area covered by the entire AR user's field of view.

In another embodiment of the invention, the AR system, or the AR user, can set a minimum guaranteed AR user's visibility percentage for the current scene. For example, if the minimum guaranteed AR user's visibility is 60%, this means that no matter how many attached or unattached AR overlays are within the user's field of view, the area that the displayed AR overlays will cover on the AR user's field of view will never be bigger than 40% of the total area of the AR user's field of view. Embodiments of the invention can achieve this minimum guaranteed AR user's visibility in various ways.

In some embodiments of the invention, the minimum guaranteed AR user's visibility can be achieved by selectively enabling or disabling (i.e. displaying or not displaying) AR overlays, until the AR user's visibility becomes larger than the minimum guaranteed AR user's visibility. In other embodiments of the invention, the minimum guaranteed AR user's visibility can be achieved by modulating the transparency of the AR overlays displayed in the AR user's field of view. In other embodiments of the invention, the minimum guaranteed AR user's visibility can be achieved by displaying pre-informational AR overlays with smaller areas. In yet other embodiments of the invention, the minimum guaranteed AR user's visibility can be achieved by a combination of disabling some AR overlays, modulating the transparency of other AR overlays and showing pre-informational AR overlays with smaller or larger areas.

Embodiments of the invention that enable or disable AR overlays in order to achieve the minimum guaranteed AR user's visibility may manage which overlays are enabled or disabled by using a FIFO (First Input First Output) queue approach. In this approach, the FIFO stores elements that reference the AR overlays. The elements in the FIFO may also contain time-stamps, so that an inspection of the time-stamps may reveal the oldest and newest AR overlays in the FIFO. The area, of the AR user's field of view, which is covered by the union of the areas of the AR overlays referred to inside the FIFO, is referred to as the FIFO's overlay coverage area. Notice that this area may be smaller than the sum of the areas of the individual AR overlay referred to inside the FIFO. The reason for this is that overlapping between the various AR overlays may occur. The capacity of the FIFO is set with respect to the maximum FIFO's overlay coverage area the FIFO can hold. If new elements are inserted in the FIFO and they contribute to an increase in the FIFO's overlay coverage area that takes it above the capacity of the FIFO, older elements in the FIFO will be removed until the FIFO's overlay coverage area is within the capacity of the FIFO. For example, the capacity of the FIFO may be set to be the maximum total overlay area that meets the minimum guaranteed AR users visibility requirement.

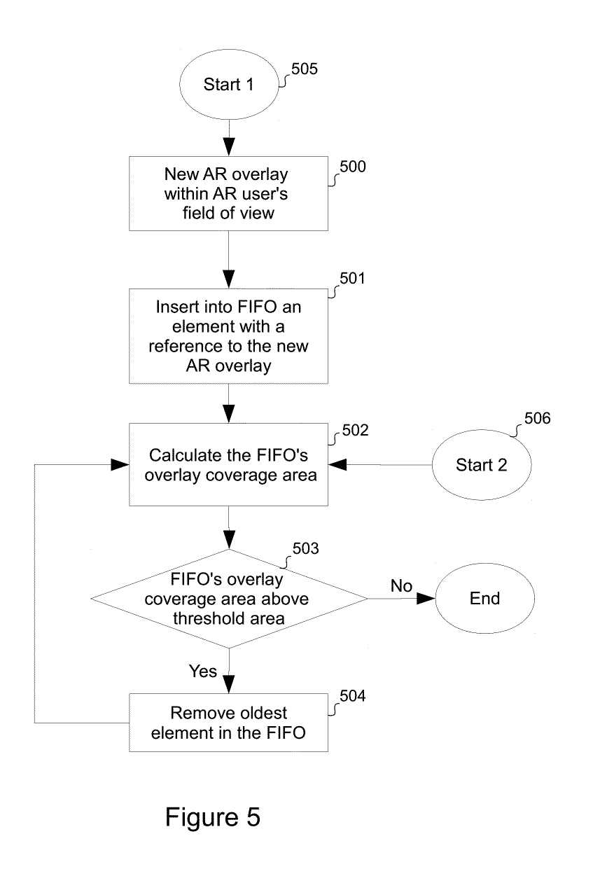

FIG. 5 shows a flowchart of a FIFO approach to manage AR overlay pollution. Starting from “Start 1” point, 505. Each time a new AR overlay appears in the AR users field of view, 500, it is enabled by default, and an element is inserted into the FIFO with a reference to the new AR overlay in the users field of view, 501. Then the FIFO's overlay coverage area is calculated, 502. Once the FIFO's overlay coverage area is calculated, it is compared with the threshold area, 503. The threshold area may be the capacity of the FIFO (in terms of how much area overlays in the FIFO can cover in the AR users field of view), or any other value smaller or equal to the capacity of the FIFO. The threshold area can be calculated from the minimum guaranteed AR users visibility. If the FIFO's overlay coverage area is not above the threshold area, then the computation finishes. If the FIFO's overlay coverage area is above the threshold area, then the oldest element (first in) in the FIFO is removed, 504, and the associated AR overlay is disabled from the AR users field of view. Then the computation of the FIFO's overlay coverage area is repeated, 502, and further AR overlays may be removed, 504, from the FIFO until the FIFO's overlay coverage area is no longer above the threshold area, 503.

Even if no new AR overlays enter the AR users field of view, AR overlays may exit the AR users field of view. These AR overlays will then be disabled and their associated area will be zero. In step 502, while the FIFO's overlay coverage area is being calculated, elements that refer to an AR overlay with zero area are automatically removed from the FIFO. This approach may also include hysteresis in the enabling or disabling of AR overlays. Hysteresis may give AR overlays that momentarily exit and then re-enter the AR users field of view a chance to remain in the FIFO queue. This can be achieved by continuing to decrease the area of AR overlays with areas smaller than or equal to zero each time step 502 is computed. Then an element is only removed from the FIFO, at step 502, if the area of the associated AR overlay reaches a predetermined negative number. The computation of the FIFO's overlay coverage area would ignore AR overlays with negative areas.

Furthermore, the area covered by the individual AR overlays in the FIFO may change due to the AR users view changing, as a result of motion and a change of view point. For this reason the elements in the FIFO will have to be continuously reprocessed as the AR users view changes. This is achieved by entering the flow chart on the point “Start 2”, 506, and continuing the loop, 502, 503, 504, disabling any necessary AR overlays until the area covered by the AR overlays in the FIFO is above the threshold area.

Other embodiments of the invention that enable or disable AR overlays in order to achieve the minimum guaranteed AR users visibility can set a spatial boundary where AR overlays within the boundary are enabled and AR overlays outside the boundary are disabled. Alternatively, depending on the particular application, the opposite may be true, such that the AR overlays within the spatial boundary are disabled and the AR overlays outside the boundary are enabled. The spatial boundary may then be adjusted, increasing or decreasing its size, so that the AR users visibility is not less than the minimum guaranteed AR users visibility.

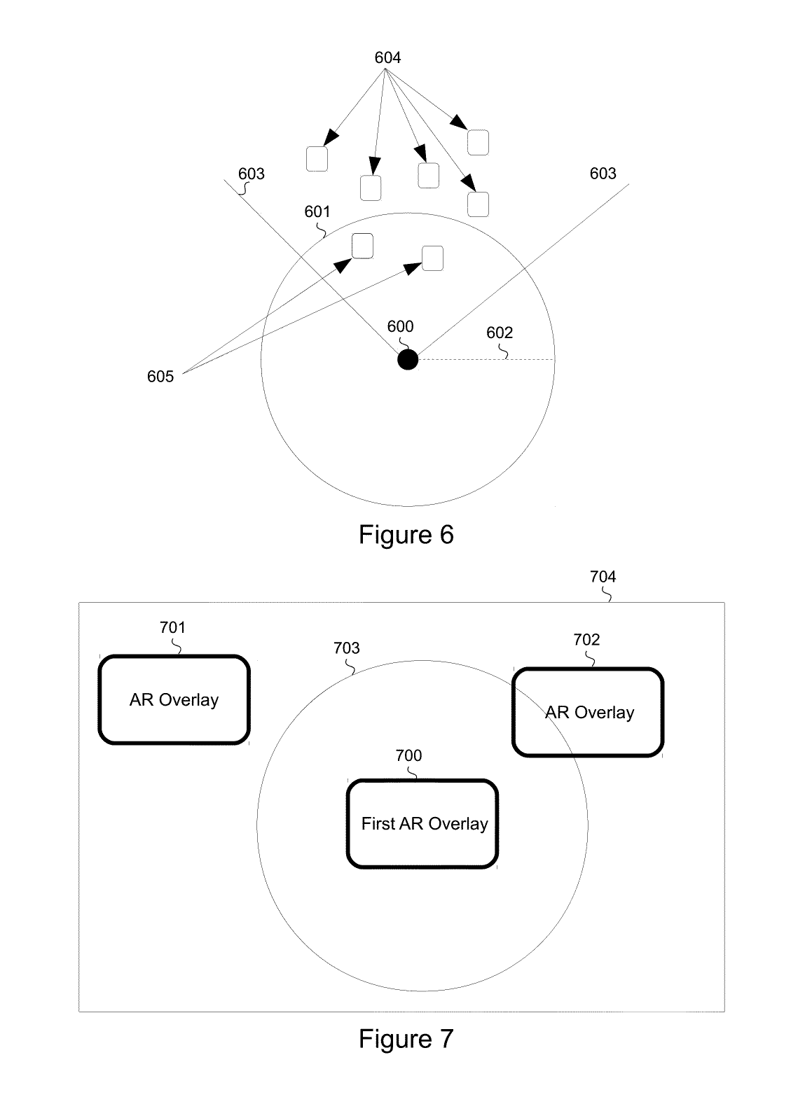

The spatial boundary may have any suitable shape. Usually spherical or cylindrical boundaries centred on the AR users location will be easier to deal with, as these will generally only require one parameter, a radius. However, the spatial boundary may be determined by the AR users current location. For example, if the AR user is on a street with buildings on both sides along the street, the spatial boundary may extend only along the street. FIG. 6 illustrates the use of a spherical spatial boundary to enable or disable AR overlays. The AR user is at the centre, 600, the spherical spatial boundary, 601, which has an initial radius 602. The AR users field of view is illustrated by the pair of lines labelled 603. Depending on the particular application, the AR overlays outside the spatial boundary, 604, may be disabled and the AR overlays inside the spatial boundary, 605, may be enabled. If the AR overlays inside the spatial boundary are enabled by default, and the AR users visibility within the AR users field of view, 603, is larger than the minimum guaranteed AR users visibility, the radius of the spatial boundary, 602, may be increased up to a predetermined maximum. This may result in new AR overlays being enabled and the AR users visibility being decreased. If the AR overlays inside the spatial boundary are enabled by default, and the AR users visibility within the AR users field of view, 603, is smaller than the minimum guaranteed AR users visibility, the radius of the spatial boundary, 602, may be decreased. This may result in current AR overlays being disabled and the AR users visibility being increased.

Some embodiments of the invention may modulate the transparency of individual AR overlays so that the total visibility of the AR user does not exceed the minimum guaranteed AR users visibility. In these embodiments of the invention, the AR users visibility is computed with the same equation (Eq. 1) as for the enabled or disabled approach, but the “total overlay area” may be computed as the sum (and not the union) of the areas of the AR overlays that are within the AR user's field of view. These areas are weighted to their individual transparencies, with weight 1 meaning no transparency and weight 0 meaning full transparency and the sum of these weighted areas is divided by the total area of the AR user's field of view. At the extremes, when the AR overlays have full transparency, weight 0, or no transparency, weight 1, this is equivalent to the disable or enable approach.

Embodiments of the invention that modulate the transparency of individual AR overlays can use a soft version of the FIFO queue and spatial boundary approaches to control the visibility of the AR user. Soft means that instead of fully disabling or enabling a certain AR overlay, the AR overlay is gradually enabled and gradually disabled accordingly.

In some embodiments of the invention, image processing techniques may be used on the image corresponding to the current AR users field of view, in order to determine which AR overlays can be enabled or disabled or have their transparency modulated. Some embodiments of the invention may use optical flow on the image corresponding to the current AR users field of view, to determine the motion of objects in the field of view. In general, the types of object motions in the AR users field of view that are of most interest are the ones that are independent to the AR user motion within a certain scene. For example, regardless of the AR user motion, optical flow may be used to determine the motion of objects moving towards or away from the AR user in addition to those simply moving with respect to the AR user. Other image processing techniques, motion sensors, geolocation or microlocation techniques can be combined to remove the AR users motion from the computation so that only the motion of objects with respect to the AR user can be estimated. If an object is detected to be moving towards the AR user, the AR system may disable any AR overlay that may occlude this object. Alternatively, if an object is detected to be moving towards the AR user, the AR system may show a warning AR overlay highlighting the moving object.

In some embodiments of the invention, attached AR overlays may remain in pre-informational form while within the AR users field of view and convert to informational form when certain types of motion are detected. Alternatively, objects within the AR users field of view may not show any AR overlays and only display a pre-informational AR overlay when certain types of motion are detected.

In other embodiments of the invention, unattached AR overlays may be completely or partially disabled or made transparent when objects in the scene are detected to show certain types of motion. This is independent of whether the moving object may or may not have an attached AR overlay. For example, if an object is moving towards the AR user, all the unattached AR overlays that cover such an object in the AR users field of view may be disabled, increased in transparency, or switched to their pre-informational form.

Some embodiments of the invention may use smartglasses or other AR capable hardware that includes a camera that can capture the AR users field of view and maybe the surroundings of the AR user. These embodiments may use image recognition techniques on the available video or image data from the cameras to recognize important objects in the scene and disable AR overlays that may occlude the important object.

Some embodiments of the invention may use a combination of information sources to manage AR overlay pollution. In a similar way to how intelligent Transportation Systems (ITS) can fuse multiple sources of information to provide a better transport experience, information sources may be fused to manage the AR overlay pollution. These information sources may include external information such Geographical Information Systems (GIS), traffic data, weather reports and other AR users statuses and motions in combination with internal sources of information particular to an AR user, such as video capture, motion sensors, geolocation sensors, etc. For example, if a first AR user starts moving in a direction that will result in a second AR user seeing an informational or pre-informational AR overlay on its field of view, this information can be fused with information local to the second AR user in order to plan ahead which AR overlays will be enabled and which level of transparency they will have.

### AR Overlay Pollution Due to Interference with Other AR Overlays

Another form of AR overlay pollution is when AR overlays interfere with each other regardless of the AR users visibility. AR overlays may overlap one on top of another resulting in occlusion of information. AR overlays may be in proximity of each other while showing conflicting information. For multiple reasons, the creator or owner of a certain AR overlay may not want other AR overlays to appear near his AR overlay. The proximity between AR overlays may be measured as: distance between AR overlays as presented in the AR users field of view; distance (Euclidean, Manhattan, Mahalanobis, etc.) between the locations of AR overlays as these are anchored in space; Embodiments of the invention that deal with separation between AR overlays may be relevant to both attached and unattached AR overlays.

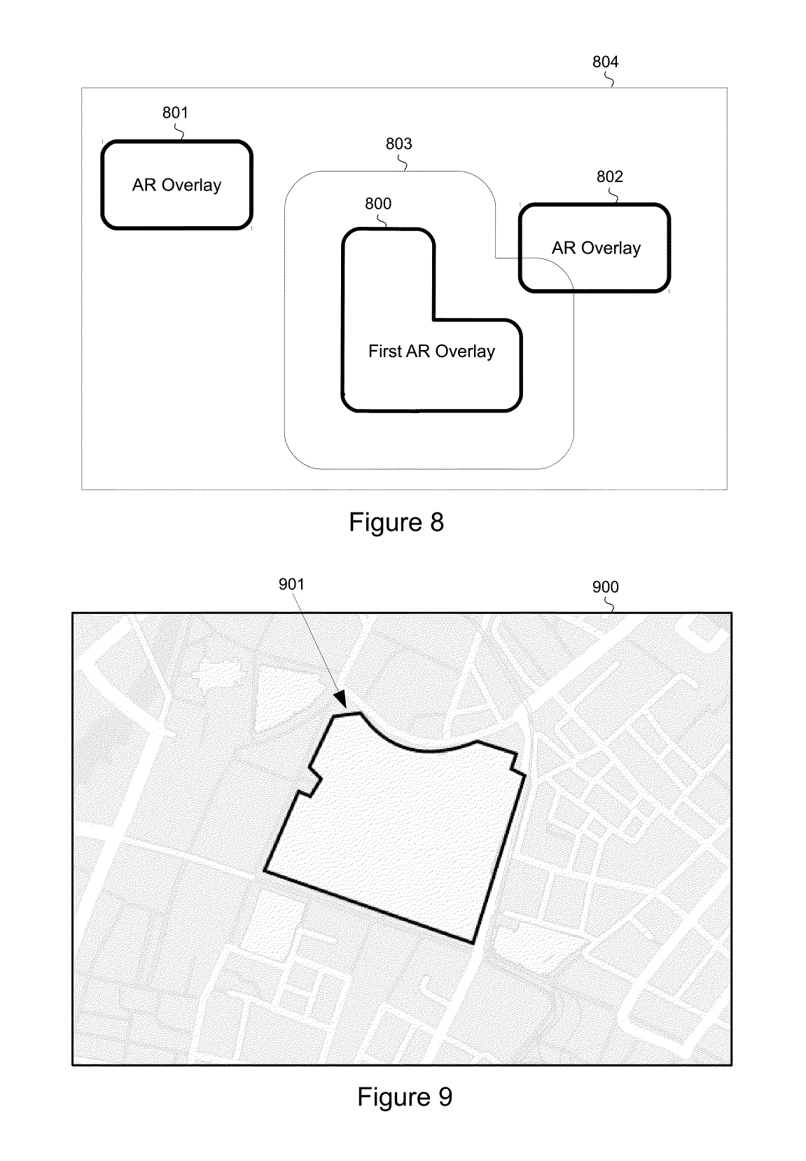

In some embodiments of the invention, a first AR overlay may have an associated buffer zone around itself, as it appears on the AR user's field of view, that may be used to prevent the presentation of other AR overlays within this buffer zone. A circular buffer zone of a predetermined radius around the centre of the first AR overlay may be used. Other buffer zones shapes may be used instead, such as rectangular or oval buffer zones centred on the AR overlay. A buffer zone determined by the repeated morphological dilation of the contour of an AR overlay may also be used. FIG. 7 shows how a circular buffer zone, centred on a first AR overlay, may be used to prevent the presentation of the other AR overlays within the buffer zone. Within the AR users field of view, represented by the rectangle 704, a first AR overlay is presented, 700. Around this first AR overlay a circular buffer zone, 703, is defined with centre on the first AR overlay 700. AR overlays (such as 702) that would be presented within, or overlapping with, the buffer zone 703 will be disabled, their transparency increased, or their location displaced to outside the buffer zone. AR overlays (such as 701) that would be presented outside the buffer zone 703 will be presented as usual. FIG. 8 shows how a buffer zone, determined by the repeated morphological dilation of the contour of an AR overlay, may be used to prevent the presentation of the other AR overlays within the buffer zone. Within the AR users field of view, represented by the rectangle 804, a first AR overlay is presented, 800. Around this first AR overlay a buffer zone 803 is defined by the repeated morphological dilation of the contour of the first AR overlay. AR overlays (such as 802) that would be presented within, or overlapping with, the buffer zone 803 will be disabled, their transparency increased, or their location displaced to outside the buffer zone. AR overlays (such as 801) that would be presented outside the buffer zone 803 will be presented as usual.

### AR Overlay Pollution Due to AR Overlays Appearing at Unwanted Locations

Another form of AR overlay pollution is when the AR overlays appear at unwanted or private locations. Embodiments of the invention may implement an exclusion area within which certain AR overlays may not be displayed, or anchored in the case of unattached AR overlays. AR overlays that are created or owned by the creator of the exclusion area may be allowed to be displayed or anchored within the exclusion area. The shape of this exclusion area can be circular, oval, rectangular, combination of simpler shapes, just a free form shape, or any of their corresponding shapes in 3 dimensions, ie. sphere, ovoid, prism, etc. In some embodiments of the invention, the exclusion area shape may have an arbitrary size and be defined relative to a point defined on some coordinate system, for example the location of another AR overlay on a map. In other embodiments of the invention, the exclusion area shape may be defined directly on a coordinate system on a map, for example covering the contour of a private property land area. And yet in other embodiments of the invention, the exclusion area shape may be defined by the coverage areas, or regions of influence, of a set of radio beacons. FIG. 9 shows a map 900 including an exclusion area 901 that may correspond to a certain building or private property area. Certain AR overlays may not be displayed within this exclusion area 901. Other AR overlays that may belong to the owner of the exclusion area may be allowed to be displayed or anchored within the exclusion area 901.

Embodiments of the invention that use an exclusion area defined on a coordinate system, may need to determine the location and orientation of an AR user within the coordinate system in order to determine whether the AR overlays that this AR user is looking at are within the safe area or not. Some embodiments of the invention that use Simultaneous Mapping and Tracking (SLAM) techniques to create a local map around the AR users location, may use the current location of the AR user within the SLAM map to determine whether AR overlays that may appear on the AR users field of view are within a exclusion area or not. Other embodiments of the invention may use geolocation services to determine the location and orientation of an AR user on a coordinate system and determine whether AR overlays that may appear on the AR users field of view are within an exclusion area or not. And yet in other embodiments of the invention may use a combination of geolocation and SLAM techniques to determine the location and orientation of an AR user and determine whether AR overlays that may appear on the AR user's field of view are within an exclusion area or not.

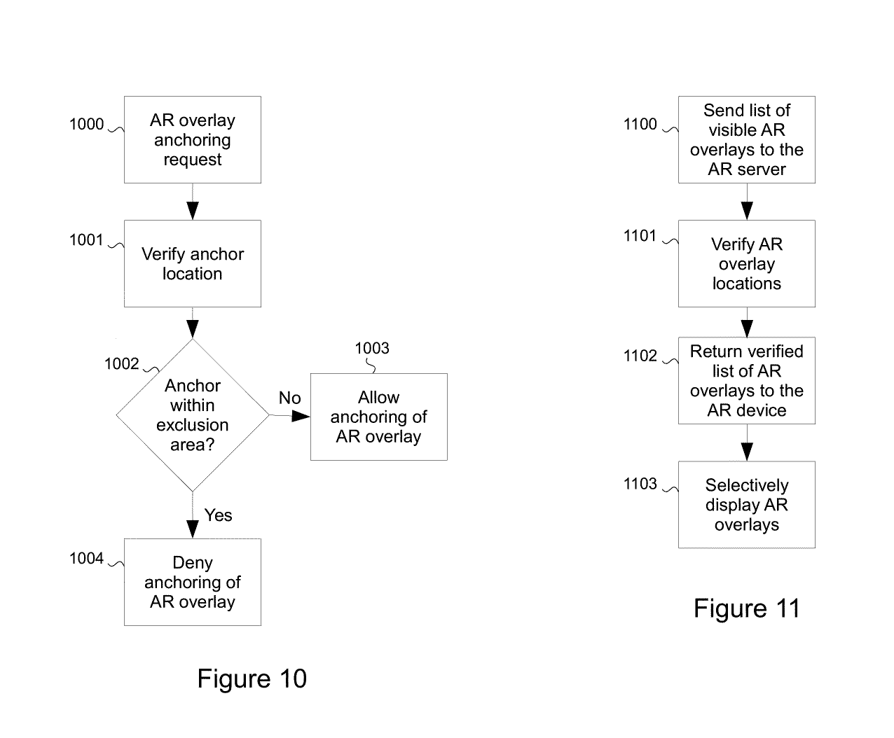

Embodiments of the invention that use an exclusion area may implement the enforcement of the exclusion area at the moment an unattached AR overlay wants to be anchored. Anchoring an AR overlay means to set the position and orientation of the AR overlay on a predefined coordinate system. Generally, the architecture of the system will be as described in FIG. 1B. FIG. 10 shows a flowchart of an implementation of an exclusion area at the time of anchoring an unattached AR overlay. In the first step 1000, an AR user decides to anchor an unattached AR overlay in a certain 3D location and orientation. Then the AR device 105 sends a request to the AR server 104 sending the location and orientation where the unattached AR overlay wants to be anchored. Alternatively, the anchoring request can be made by any third party that has capability of anchoring new overlays, not necessarily an AR user in the field. In this case the request may still be sent to the AR server for verification. In step 1001, the AR server may use information from various sources to decide if the anchoring or the unattached AR overlay is allowed. For example, the AR server may have a map with predefined exclusion areas. If the unattached AR overlay location falls within an exclusion area, or a buffer zone around the exclusion zone, and the AR user is not allowed to anchor AR overlays on that exclusion area, then the AR server will deny the anchoring of the unattached AR overlay, otherwise it will allow the anchoring and register all relevant data. Depending on the reply from the AR server 104, in step 1002, the AR device 105 may allow, step 1003, or deny, step 1004, the anchoring of the unattached AR overlay. The AR device may inform the user that the anchoring of the AR overlay has been or hasn't been successful. If the anchoring of the AR overlay is unsuccessful, the AR user may have to anchor the AR overlay in some other location.

Exclusion areas may be displayed as AR overlays themselves so that AR users can know in advance if they are allowed to anchor an unattached AR overlay at a certain location.

Some embodiments of the invention may prevent AR overlays from showing on an AR user's field of view if the AR overlay is within an exclusion area for which the AR overlay has no permission. These embodiments of the invention perform the verification step during the presentation of the AR overlay instead of during the AR overlay anchoring request. FIG. 11 shows a flowchart of an implementation of an exclusion area with a verification step during the presentation of the AR overlay. In the first step 1100, the AR device 105 sends to the AR server 104 a list of visible AR overlays. The visible AR overlays may be the AR overlays visible on the AR users field of view at a given moment in time. Sending of this list of AR overlays may happen with a certain frequency. If the frequency is higher the AR overlays appearing on the exclusion areas can be disabled sooner, but there would also be a higher load on the communications subsystem between the AR devices 105 and the AR server 104. Therefore, the frequency at which this list of visible AR overlays is sent must balance the load on the communication subsystem and the speed with which AR overlays in exclusion areas are disabled. During the second step 1101, the AR server 104 verifies whether the locations of the AR overlays in the list are within an exclusion area. In step 1102, the result of this verification is sent back to the AR device 105. Finally, in step 1103 the list of AR overlays is displayed in the AR users field of view, excluding the AR overlays that have been verified to appear within an exclusion area. In some embodiments of the invention the AR device may have locally all the necessary data to decide whether an AR overlay is within an exclusion area or not. In these embodiments of the invention, all the steps of FIG. 11 may happen in the AR device.

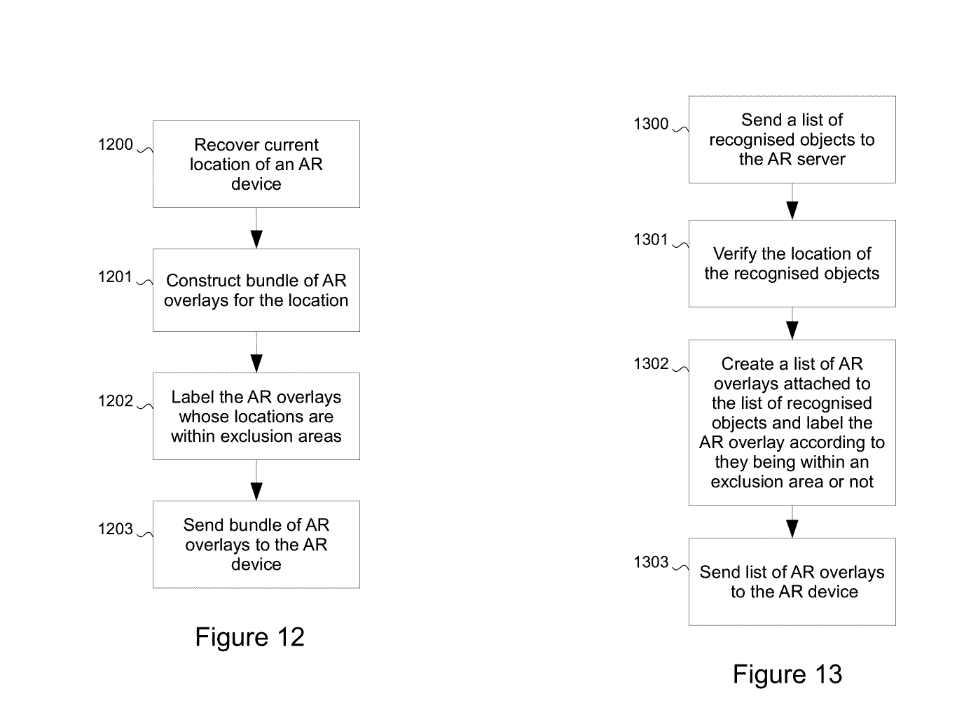

In some embodiments of the invention, the AR server 104 may label the AR overlays, indicating whether an AR overlay is, or is not, within an exclusion zone, at the time of sending the AR overlay information to the AR devices 105. FIG. 12 shows a flowchart of an implementation of the AR server labelling a bundle of AR overlays before sending it to an AR device. In step 1200, the AR server 104 receives the current location of an AR device 105. In order to minimize communications bandwidth, a number of AR overlays near the current location of the AR device will be selected and bundled together, step 1201, instead of sending one AR overlay at a time. The locations of the AR overlays in the bundle will be labelled to reflect whether they are within any exclusion area, step 1202. Finally, the labelled bundle of AR overlays is sent to the AR device, 1203. The AR overlays labelled as being within an exclusion area may optionally be removed at this step, 1203, so that the AR device does not even know about their existence. Alternatively, the AR device 105 may decide itself whether to display a particular AR overlay based on the labels of the received bundle or AR overlays.

In other embodiments of the invention, the verification step of whether an AR overlay is within an exclusion area may take place when a certain object is recognised in the AR users field of view. This type of embodiments can be especially useful for attached AR overlays, which are attached to an object. The AR device 105 may present the attached AR overlay in general circumstances but not if the object is placed within an exclusion area. FIG. 13 shows a flowchart of an implementation of labelling attached AR overlays depending on the location of the recognised objects. In step 1300, the AR device sends to the AR server a list of recognised objects together with the AR device's location. The AR server 104 can then verify if the locations of the recognised object are within any exclusion areas, step 1301. In step 1302 the AR server creates a list of AR overlays associated to the list of recognised objects and labels the AR overlays according to they being within an exclusion area or not. Alternatively, the recognised objects that are within an exclusion area may have removed their attached AR overlays from the list of AR overlays, so that the AR device does not even know about their existence. Finally, the list is sent back to the AR device, step 1303, which will show the AR overlays that are attached to object outside any exclusion area. Alternatively, some embodiments of the invention may perform the recognition of objects on the AR server 104. In this embodiments the step 1300 would be replaced by sending an image, or a set of features, to the AR server, and this performing a recognition step on the image or features, therefore producing a list of recognised objects. The rest of the flowchart would proceed as before.

While various embodiments of the invention have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

1. A system enabling an Augmented Reality (AR) capable system to prevent the possible AR overlay pollution of an AR user's field of view, the system comprising:
A hardware means of sensing the position and orientation associated with the AR user's field of view;
A hardware means of accessing local or remote data relevant to the AR user's field of view;
A hardware means of displaying AR overlays on the AR user's field of view;
A means of managing the displaying of AR overlays in the AR user's field of view so that AR overlay pollution is prevented.

2. A system according to claim 1, wherein the means of managing the displaying of AR overlays in the AR user's field of view involves the use of a pre-informational AR overlay form, the use of an informational AR overlay form and a means of transitioning from the pre-informational AR overlay form to the informational AR overlay form and vice versa.

3. A system according to claim 1, wherein the means of managing the displaying of AR overlays in the AR user's field of view involves initially displaying the AR overlays in pre-informational form for a predetermined amount of time, then the AR overlays are displayed in a waiting form, until the AR user selects an AR overlay, and then the selected AR overlay is displayed in informational form.

4. A system according to claim 1, wherein the means of managing the displaying of AR overlays in the AR user's field of view involves displaying the AR overlays in regions of the AR user's field of view that do not interfere or distract the AR user, and then allowing the AR user to select any of the AR overlays, the selected AR overlay then moving to a position in the AR user's field of view that allows the AR user to confortably inspect the AR overlay.

5. A system according to claim 1, wherein the means of managing the displaying of AR overlays in the AR user's field of view involves calculating an AR user's visibility measure and a means of filtering the AR overlays so that a mimimum guaranteed AR user's visibility is achieved.

6. A system according to claim 5, wherein the means of filtering the AR overlays uses a FIFO containing references to AR overlays in the AR user's field of view.

7. A system according to claim 5, wherein the means of filtering the AR overlays uses a moving spatial boundary.

8. A system according to claim 1, wherein the means of managing the displaying of AR overlays in the AR user's field of view involves detecting moving objects in the AR user's field of view and transitioning the AR overlays from pre-informational form to informational form, and vice versa, according to the types of object motions.

9. A system according to claim 1, wherein the means of managing the displaying of AR overlays in the AR user's field of view involves identifying objects in the AR user's field of view and transitioning the AR overlays from pre-informational form to informational form, and vice versa, according to the identity of said objects.

10. A system according to claim 1, wherein the means of managing the displaying of AR overlays in the AR user's field of view involves defining a buffer zone around individual AR overlays, this buffer zone enabling or disabling the presentation of other AR overlays within that buffer zone.

11. A system according to claim 1, wherein the means of managing the displaying of AR overlays in the AR user's field of view involves defining exclusion areas on a map within which only certain AR overlays can be displayed.

12. A system according to claim 11, wherein the means of selecting which AR overlays can be displayed or not on an exclusion area is enforced at the time of anchoring the AR overlay within the exclusion area.

13. A system according to claim 11, wherein the means of selecting which AR overlays can be displayed or not on an exclusion area is enforced at the time of displaying the AR overlay on the AR user's field of view.

14. A system according to claim 11, wherein the means of selecting which AR overlays can be displayed or not on an exclusion area is enforced at the time a certain object is identified in the AR user's field of view.

15. A system enabling an AR capable system to protect the space around certain AR overlays so that other AR overlays can not be displayed within the protected space, the system comprising:
A hardware means of sensing the position and orientation associated with an AR user's field of view;
A hardware means of accessing local or remote data relevant to the AR user's field of view;
A hardware means of displaying AR overlays on the AR user's field of view;
A means of protecting the space around certain AR overlays so that other AR overlays can not be displayed within the protected space.

16. A system according to claim 15, wherein the means of protecting the space around certain AR overlays involves defining a buffer zone around individual AR overlays, this buffer zone enabling or disabling the displaying of other AR overlays within that buffer zone.

17. A system enabling an AR capable system to prevent the displaying of AR overlays in unwanted locations, the system comprising:
A hardware means of sensing the position and orientation associated with an AR user's field of view;
A hardware means of accessing local or remote data relevant to the AR user's field of view;
A hardware means of displaying AR overlays on the AR user's field of view;
A means of preventing the displaying of AR overlays in unwanted locations;

18. A system according to claim 17, wherein the means of preventing the displaying of AR overlays in unwanted locations involves defining exclusion areas on a map within which only certain AR overlays can be displayed.

19. A system according to claim 18, wherein the means of selecting which AR overlays can be displayed or not on an exclusion area is enforced at the time of anchoring the AR overlay within the exclusion area.

20. A system according to claim 18, wherein the means of selecting which AR overlays can be displayed or not on an exclusion area is enforced at the time of displaying the AR overlay on the AR user's field of view.

21. A system according to claim 18, wherein the means of selecting which AR overlays can be displayed or not on an exclusion area is enforced at the time a certain object is identified in the AR user's field of view.
